(19) United States
(12) Patent Application Publication
(10) Pub. No.: US 2005/0263492 A1
(43) Pub. Date: Dec. 1, 2005

(54) Molded arc chute

(75) Inventor: Brian Timothy McCoy, Grayson, GA (US)

Correspondence Address: James A. Wilke;Foley & Lardner LLP, 777 East Wisconsin Avenue, Milwaukee, WI, 53202-5306, US

(73) Assignee: Siemens Energy & Automation, Inc.

(21) Appl. No.: 10/857,102

(22) Filed: May 28, 2004

(51) Int. Cl. H01H 9/40

(52) U.S. Cl. 218/34

(57) ABSTRACT

An electric arc extinguishing apparatus for a circuit breaker having a line terminal. The electric arc extinguishing apparatus comprises a one-piece housing having a first sidewall in a spaced relationship with a second sidewall. A plurality of arc plates are disposed within the housing between the sidewalls.

### BACKGROUND OF THE INVENTION

The present invention relates generally to the field of circuit breakers, and more particularly to a molded arc chute for a circuit breaker.

In general, the function of the circuit breaker is to electrically engage and disengage a selected circuit from an electric power supply. This function occurs by engaging and disengaging a pair of operating contacts for each phase of the circuit breaker. The circuit breaker provides protection against persistent over current conditions and against the very high currents produced by short circuits. Typically, one of each pair of the operating contacts are supported by a pivoting contact arm while the other operating contact is substantially stationary. The contact arm is pivoted by an operating mechanism such that the movable contact supported by the contact arm can be engaged and disengaged from the stationary contact.

There are two modes by which the operating mechanism for the circuit breaker can disengage the operating contacts: the circuit breaker operating handle can be used to activate the operating mechanism; or a tripping mechanism, responsive to unacceptable levels of current carried by the circuit breaker can be used to activate the operating mechanism. For many circuit breakers, the operating handle is coupled to the operating mechanism such that when the tripping mechanism activates the operating mechanism to separate the contacts, the operating handle moves to a fault or tripped position.

To engage the operating contacts of the circuit breaker, the circuit breaker operating handle is used to activate the operating mechanism such that the movable contacts engage the stationary contacts. A motor coupled to the circuit breaker operating handle can also be used to engage or disengage the operating contacts the motor can be remotely operated.

A typical industrial circuit breaker will have a continuous current rating ranging from as low as 7 amps to as high as 400 amps. The short circuit currents experienced by the circuit breaker can be considerably higher than the rated amperage. The tripping mechanism for the circuit breaker usually consists of a thermal overload release and a magnetic short circuit release.

To limit the duration and intensity of short circuit currents, the circuit breaker must, within the shortest possible time, separate its contacts and extinguish the resulting electric arcs. The circuit breaker must operate to shorten both time of intervention, i.e., commence movement of the contacts away from each other and the time of extinction of the arc by increasing arc voltage. The known manner to extinguish the arc is to extend it and to cool it. Prior art methods have included puffing air or gas into the arc chamber while the contacts of the circuit breaker move apart. Another solution has been to install a magnetic motor which forces the arc in a selected direction typically into an array of arc baffles. A further solution is meant to increase the number of baffles in the stacked array and insert the insulating elements between the arc baffles to promote a series of small arcs thereby contributing to the increase in the arc voltage and ultimate extinguishment of the arc. All of these methods or apparatus of arc extinction involve additional parts adding to the manufacturing and maintenance costs of the circuit breaker as well as to the complexity of the circuit breaker.

Thus, there is a need for an arc extinguishing apparatus or arc chute that will extend and cool the electric arc formed during separation of circuit breaker contacts, while underload, preferably without pneumatic or electromagnetic elements. There is a further need to provide an arc extinguishing apparatus with a minimum of unique elements. There is also a need for an arc extinguishing apparatus that can be used with several types of circuit breakers, such as circuit breakers with a single movable contact element, with movable contacts as well as with single and multiple pole circuit breakers.

### SUMMARY OF THE INVENTION

There is provided an electric arc extinguishing apparatus for a circuit breaker having a line terminal. The electric arc extinguishing apparatus comprises a one-piece housing having a first sidewall in a~spaced relationship with a second sidewall. A plurality of arc plates are disposed within the housing between the sidewalls.

There is also provided a molded case circuit breaker. The circuit breaker includes a molded case, a first terminal and a second terminal in the case. A first contact electrically coupled to the first terminal and a second contact electrically coupled to the second terminal. An electrical arc extinguishing apparatus is mounted in the case and positioned in confronting relation with the first and second contacts. The arc extinguishing apparatus comprises a one-piece housing having a first sidewall in a spaced relationship with a second sidewall. A plurality of arc plates are disposed within the housing between the sidewalls.

There is further provided a molded case circuit breaker including a first and second terminal and having first and second contacts coupled to the first and second terminals, respectively. An operating mechanism coupled to one of the first and second contacts to cause the respective contact to disengage the other of the contacts in response to at least one of an overload or short circuit condition between the first and second terminals. An arc chute including metallic plates supported by plastic side walls, and located within the circuit breaker such that the arc chute is exposed to arcing which may occur when the contacts are disengaged, wherein the plastic side walls are integrally molded into a single support for the plates.

### BRIEF DESCRIPTION OF THE DRAWINGS

FIG. 1 is a perspective view of an exemplary embodiment of a molded case circuit breaker including an exemplary embodiment of an electric arc extinguishing apparatus in each pole.

FIG. 2 is a rear aspect perspective view of an exemplary embodiment of an electric arc extinguishing apparatus illustrating placement of electric arc plates in the one-piece housing, with one arc plate having an arc runner.

FIG. 3 is a perspective view of an exemplary embodiment of an arc plate including an arc runner.

FIG. 4 is a front aspect perspective view of the arc extinguishing apparatus illustrated in FIG. 2.

FIG. 5 is a sectional view of the circuit breaker illustrated in FIG. 1 along the line 5-5, illustrating the electric arc extinguishing apparatus positioned in confronting relation with the first and second contact of one pole of the circuit breaker.

FIG. 6 is a partial top sectional view of the electric arc extinguishing apparatus illustrated in FIG. 5 along the lines 6-6.

FIG. 7 is a partial sectional view of the electric arc extinguishing apparatus illustrated in FIG. 6, along the lines 7-7.

### DETAILED DESCRIPTION OF THE EXEMPLARY EMBODIMENTS

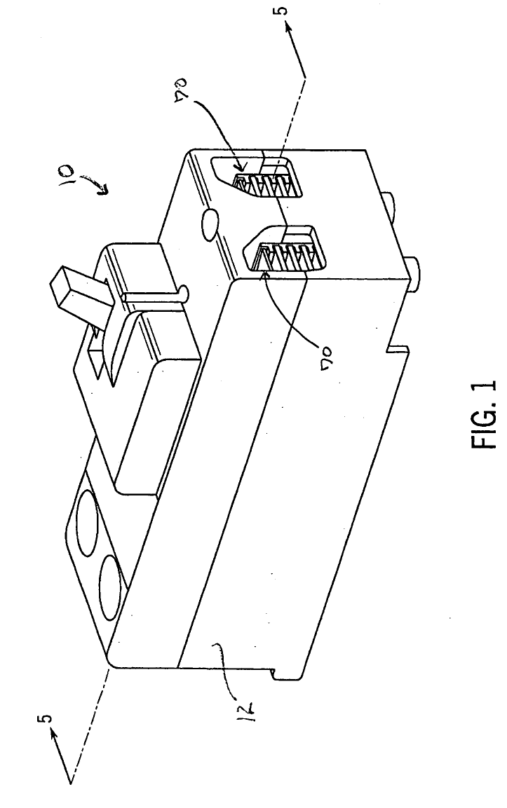

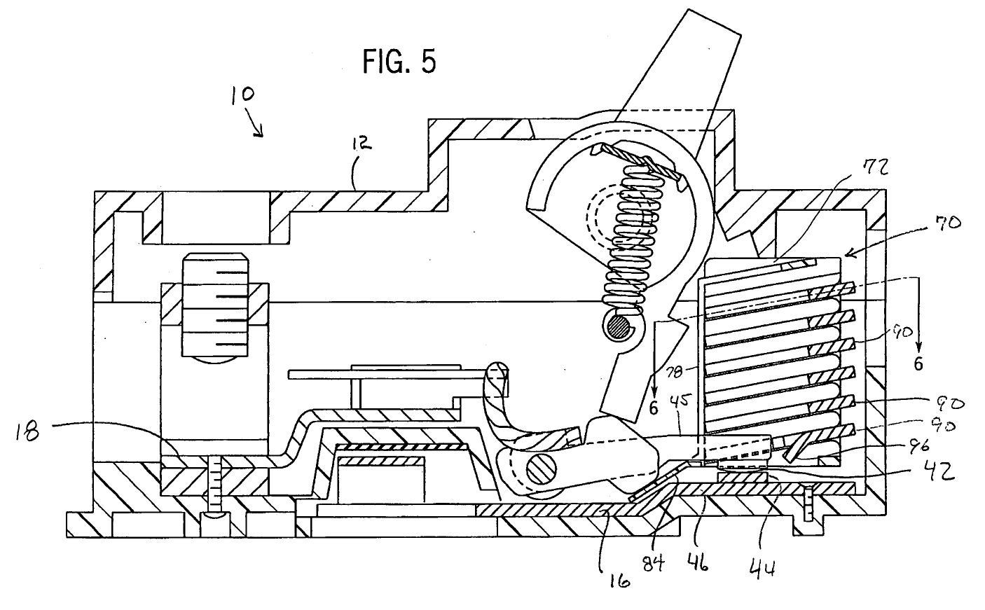

Referring to the figures, FIG. 1 generally illustrates a multi-phase molded case circuit breaker 10 of the type which includes an operating mechanism having a pivoting member with a handle. The pivoting member and handle are movable between an “ON” position, an “OFF” position and a “TRIPPED” position. The exemplary circuit breaker 10 is a two pole breaker having two sets of contacts for interrupting current at each of the two respective electrical transmission phases. (See FIGS. 1 and 5.) In the exemplary embodiment of the circuit breaker, each phase includes separate breaker contacts in a trip mechanism. The circuit breaker includes an operating mechanism which controls the switch of all poles of the breaker. Although an embodiment of the circuit breaker is described in the context of a two phase circuit breaker, it is contemplated that it may be practiced in a single phase circuit breaker or in other multi-phase circuit breakers.

Referring to FIG. 5, an embodiment of a molded case circuit breaker 10 includes a molded case 12 which typically is composed of a non-metallic insulative material that can be molded by for example injection molding. The circuit breaker 10 typically includes a first terminal 18 such as a load terminal and a second terminal 16 such as a line terminal. Each of the first and second terminals 16, 18 are coupled to contact arms. A movable contact arm 45 supports a movable contact 42 and a stationary contact arm 46 supports a stationary contact 44. As described above, electrical energy passes from the first terminal through the contact arms 45, 46 and the contacts 42, 44 to the second terminal when the circuit breaker 10 is placed in an electrical circuit. The contacts 42, 44 are typically composed of electrically conducting metal such as copper or aluminum and they may be plated with nickel or other metals.

During operation of the circuit breaker 10, that is to say when the two contacts 42, 44 separate while under load, an electrical arc is drawn between the two contacts 42, 44 as they move apart. During such arcing, the material of which the contacts 42, 44 are constructed tend to pit and vaporize while the arc is sustained between the two contacts. Such action shortens the useful life of the circuit breaker 10. The present embodiment of the electric arc extinguishing apparatus 70 facilitates the transfer of the electric arc from the contacts 42, 44 to the electric arc extinguishing apparatus 70.

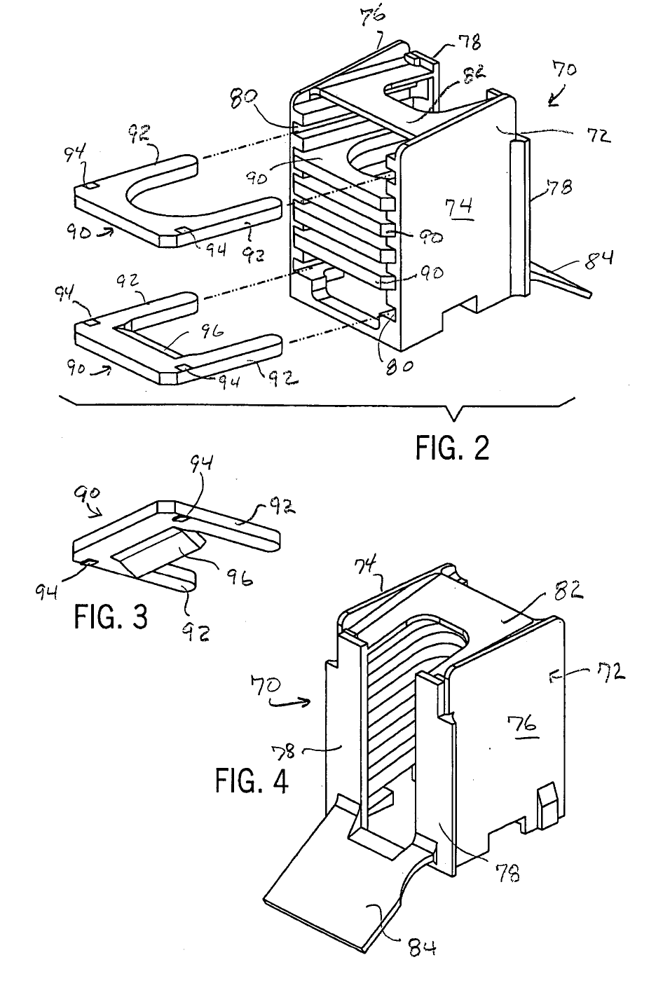

An exemplary embodiment of an electric arc extinguishing apparatus 70 is best seen by referring to FIGS. 2 and 4 wherein a one piece housing 72 includes a first sidewall 74 in a spaced relationship with a second sidewall 76. A plurality of arc plates 90 are disposed within the housing 72 between the sidewalls 74, 76. The one piece housing 72 and the arc plates 90 form an arc chute.

One embodiment of the electric arc extinguishing apparatus 70 provides an arc runner 96 on one of the arc plates 90. (See FIG. 3) A preferred location for the arc runner is on the lowest arc plate 90 disposed in the housing 72. The arc runner 96 can be integral with the bottom arc plate 90. The arc plates 90 are fabricated from a ferromagnetic material, preferably steel with a nickel plating.

Another embodiment provides arc plates 90 without an arc runner. It is also contemplated that an arc runner 96 may be provided on an arc plate 90 that is disposed at the top of the arc chute of the electronic arc extinguished apparatus 70.

The arc plates 90 can be configured in various geometric shapes, such as a U-shape plate. The arc plates 90 are mounted within the housing 72 in a spaced apart relationship from each other by inserting the arc plates 90 in slots 80 formed in the one piece housing 72. The arc plates slots 80 preferably are formed in the first and second sidewalls 74, 76 of the housing 72. The arc plates 90 are arranged in a substantially parallel orientation at an angle with respect to the sidewalls 74, 76 other than zero. The angle facilitates the extension of the electric arc in the arc chute of the electric arc extinguishing apparatus 70 up and away from the line terminal 16 of the circuit breaker 10. Such orientation assists in preventing a terminal-to-terminal electrical connection formed by the hot ionized gasses expelled from the circuit breaker 10 during its operation under load. It is also contemplated that the electric arc extinguishing apparatus 70 is used without arc plates to provide line terminal insulation and arc suppression.

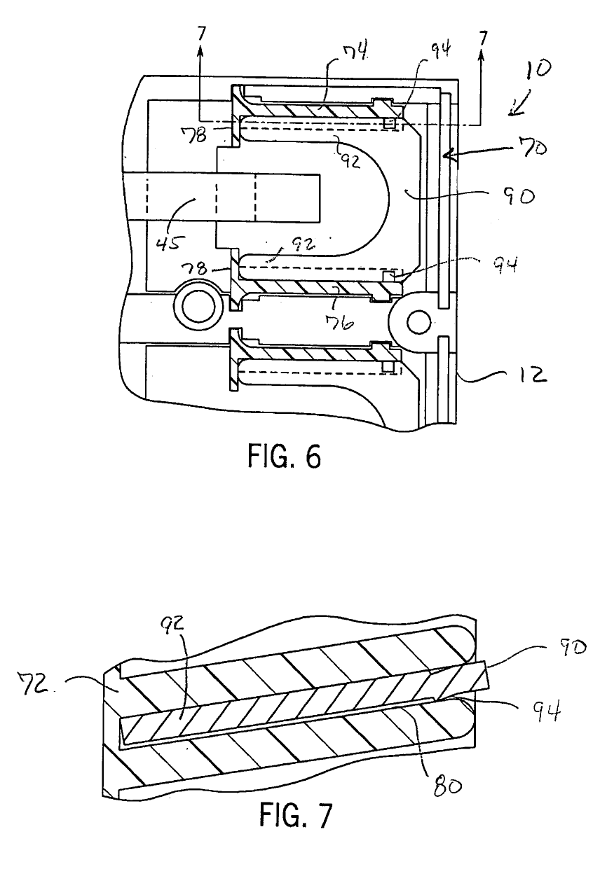

The housing 72 can be fabricated, for example by injection molding from any suitable insulating material having adequate strength to support the arc plates 90 and withstand the pressures and heat generated during the circuit breaker 10 operation. The housing 72 can be composed of a thermoplastic material, such as nylon thermoplastic. The housing 72 is placed in the breaker housing 12 (See FIGS. 5 and 6) for each pole of the circuit breaker 10. The contacts 42 and 44 are positioned within the arc chute of the electric arc extinguishing apparatus 70, between the legs of the U-shaped arc plates 90. (See FIG. 6)

Each arc plate 90 having a U-shaped configuration includes arc plate legs 92 as best seen in FIGS. 2 and 6. Each arc plate 90 is provided with a plurality of barbs 94 formed on the arc plates to position and secure the arc plates 90 within the housing 72. The barbs can be formed in the arc plates 90 during fabrication of the arc plate 90 by a stamping process.

The one piece housing 72 can also be provided with a top portion 82 and a contact ramp portion 84 also referred to as a terminal shield. The housing 72 also includes end cap portions 78 which are formed as part of the first and second sidewalls 74, 76 of the housing 72. The end caps 78 additionally prevent the arc plates 90 from moving beyond the sidewalls 74, 76 of the housing 72 but also protect the arc plate legs 92 during operation of the circuit breaker 10. (See FIGS. 4 and 6.) The end caps 78 are formed from the same electrically insulating material as the sidewalls, 72, 74, contact ramp portion 84 and the top portion 82 of the housing 72. During the presence of an electrical arc, the end caps 78 ablate and outgas material as a result of being exposed to the high heat from the electrical arc. The gasses produced assist in cooling the arc and increase the resistance of the conducting plasma generated within the arc chamber which therefore, increases the arc voltage and accelerates the extinguishment of the electrical arc. The gasses generated also assist in blowing the electrical arc away from the contacts 42, 44 in the circuit breaker 10. The end cap portion 78 also prevents undesirable electrical arcing between the movable contact arm 45 and the arc plates 90 and other parts of the operating mechanism of the circuit breaker 10.

The electrical arc extinguishing apparatus 70 can also be configured to retain the line terminal 16 in the circuit breaker 10.

While the embodiments illustrated in the figures and described above are presently preferred, it should be understood that these embodiments are offered by way of example only. The invention is not intended to be limited to any particular embodiment, but is intended to extend to various modifications that nevertheless fall within the scope of the appended claims. For example, other types of ferromagnetic material can be utilized for the arc plates and different shapes can be utilized for the arc plates. It is also contemplated that an electronic trip unit can be utilized. It is further contemplated that the trip mechanism having a bi-metal or electronic trip unit and load terminal be housed in a separate housing capable of mechanically and electrically connecting to another housing containing the operating mechanism and line terminal of the circuit breaker thereby providing for a quick and easy change of current ratings for an application of the circuit breaker contemplated herein. The modifications will be evident to those with ordinary skill in the art.

1. (canceled)

2. The apparatus of claim 10, including an arc runner on at least one of the arc plates.

3. The apparatus of claim 2, wherein the arc runner is on the lowest arc plate disposed within the housing.

4. The apparatus claim 10, wherein the arc plates are U-shaped.

5. The apparatus of claim 10, wherein the arc plates are mounted Within the housing in a spaced apart relationship from each other.

6. The apparatus of claim 10, wherein the arc plates are orientated at an angle other than zero with respect to the sidewalls.

7. The apparatus of claim 10, including a plurality of barbs formed on the arc plates to secure the arc plates within the housing.

8. The apparatus of claim 10, wherein the housing is configured to retain the line terminal in the circuit breaker.

9. (canceled)

10. An electric arc extinguishing apparatus for a circuit breaker having a line terminal comprising:
a one piece housing composed of nylon thermoplastic having a first sidewall in a spaced relationship with a second sidewall; and
a plurality of arc plates disposed within the housing between the sidewalls.

11. (canceled)

12. The molded case circuit breaker of claim 20, including an arc runner on at least one of the arc plates.

13. The molded case circuit breaker of claim 12, wherein the arc runner is on the lowest arc plate disposed within the housing.

14. The molded case circuit breaker of claim 20, wherein the arc plates are U-shaped.

15. The molded case circuit breaker of claim 20, wherein the arc plates are mounted within the housing in a spaced apart relationship from each other.

16. The molded case circuit breaker of claim 20, wherein the arc plates are orientated at an angle other than zero with respect to the sidewalls.

17. The molded case circuit breaker of claim 20, including a plurality of barbs formed in the arc plates to secure the arc plates within the housing.

18. The molded case circuit breaker of claim 20, wherein the housing is configured to retain the line terminal in the circuit breaker.

19. (canceled)

20. A molded case circuit breaker comprising:
a non-metallic molded case;
a first terminal and a second terminal in the case;
a first contact electrically coupled to the first terminal;
a second contact electrically coupled to the second terminal; and
an electric arc extinguishing apparatus mounted in the case and positioned in confronting relation with the first and second contact, the arc extinguishing apparatus comprising:
a one piece housing composed of nylon thermoplastic having a first sidewall in a spaced relationship with a second sidewall; and
a plurality of arc plates disposed within the housing between the sidewalls.

21. A molded case circuit breaker comprising:
first and second terminals;
first and second contacts coupled to the first and second terminals, respectively;
an operating mechanism coupled to one of the first and second contacts to cause the respective contact to disengage the other of the contacts in response to at least one of an overload or short circuit condition between the first and second terminals; and
an arc chute including metallic plates supported by plastic side walls, and located within the circuit breaker such that the arc chute is exposed to arcing which may occur when the contacts are disengaged, wherein the plastic side walls are integrally molded into a single support for the plates and the walls are composed of nylon thermoplastic.

22. The circuit breaker of claim 21, wherein exposure to arcing causes the sidewalls to generate a gas to aid in quenching the arc.

23. The circuit breaker of claim 22, wherein at least one terminal and the arc chute are mechanically coupled to secure the terminal within the circuit breaker.

24. The circuit breaker of claim 21, including a nylon thermoplastic terminal shield integrally formed with the nylon thermoplastic sidewalls.
